(19) United States
(12) Patent Application Publication
(10) Pub. No.: US 2025/0230520 A1
(43) Pub. Date: Jul. 17, 2025

(54) SHORT PROCESS METHOD FOR EXTRACTING PRECIOUS METALS BY INTEGRATING THIOSULFATE ELECTROCHEMICAL LEACHING AND RECOVERY

(71) Applicant: Wuhan University Of Technology, Wuhan (CN)

(72) Inventors: Feifei Jia, Wuhan (CN); Huan Zhang, Wuhan (CN); Peng Chen, Wuhan (CN); Shaoxian Song, Wuhan (CN)

(21) Appl. No.: 18/775,145

(22) Filed: Jul. 17, 2024

Related U.S. Application Data
(63) Continuation of application No. PCT/CN2024/087222, filed on Apr. 11, 2024.

(30) Foreign Application Priority Data
Jan. 12, 2024 (CN) 202410050518X

(51) Int. Cl. C22B 3/04; C22B 11/00; C25C 1/20

(52) U.S. Cl. CPC C22B 3/045; C22B 11/04; C22B 11/046; C25C 1/20

(57) ABSTRACT

The invention discloses a short process method for extracting precious metals by integrating thiosulfate electrochemical leaching and recovery, which includes: dissolving thiosulfate and an electrolyte, adding an alkaline solution, stirring evenly to obtain an electrolytic solution; adjusting the pH of the electrolytic solution to 7-13, then placing the electrolytic solution and materials containing precious metals in the electrolytic cell, and using an electrode system set in an electrolytic cell for electrolysis reaction, so that precious metals are leached at the anode and deposited at the cathode; collecting precious metals deposited on the cathode. This invention can simultaneously achieve the integrated extraction of anode precious metal leaching and cathode precious metal ion electrolytic deposition, as well as precious metal leaching and recovery in one reaction device; It has the advantages of high extraction efficiency, short process flow, low reagent consumption, low energy consumption, and no pollution.

### FIELD OF THE DISCLOSURE

The disclosure relates to a short process method for extracting precious metals by integrating thiosulfate electrochemical leaching and recovery, which belongs to the field of wet metallurgy technology.

### BACKGROUND

Precious metals are strategic mineral resources that ensure national economic and financial security. Currently, there are mainly two refining methods: pyrometallurgy and hydrometallurgy. Due to its advantages of low carbon, environmental protection, and low energy consumption, wet extraction has been widely studied. The essence of its extraction reaction is an oxidation-reduction reaction, in which precious metals lose electrons and are oxidized into precious metal ions entering the solution, and then the enriched precious metal ions are reduced to elemental recovery. The wet extraction process includes: leaching precious metal materials with leaching agents such as cyanide, thiosulfate, or thiourea; Subsequently, the precious metal coordination ions in the leaching solution are adsorbed using activated carbon or resin; Then desorb the gold loaded charcoal or resin to obtain a precious liquid; Finally, the precious metal coordination ions in the precious liquid are reduced by displacement or electrowinning to obtain the precious metal elemental. The oxidation leaching of precious metal materials and the reduction and recovery of precious metal coordination ions in existing processes are independent of each other. The entire wet leaching process is complex, leading to problems such as long leaching cycles, low efficiency, and high costs for precious metal extraction.

### SUMMARY

The present invention discloses a short process method for extracting precious metals by integrating thiosulfate electrochemical leaching and recovery, which solves problems of complex process flow, long extraction cycle, low efficiency, and high cost in the current hydrometallurgical extraction of precious metals.

In order to achieve the above technical objectives, the following technical solutions are adopted in this application:

The short process method for extracting precious metals by integrating thiosulfate electrochemical leaching and recovery comprises the following steps:
S1, dissolving a thiosulfate and an electrolyte, adding an alkaline solution, stirring evenly to obtain an electrolytic solution; the electrolyte is a salt that does not contain thiosulfate;
S2, adjusting the pH of the electrolytic solution to 7-13, then placing the electrolytic solution and materials containing precious metals in the electrolytic cell, and using an electrode system set in an electrolytic cell for electrolysis reaction, so that precious metals are leached at the anode and deposited at the cathode; the voltage of the electrolysis reaction is 0.1-3 V;
S3, collecting precious metals deposited on the cathode.

Preferably, the sustained release agent is a flocculant or superplasticizer, and the addition amount of the sustained release agent is ≤2.00% by mass of the sample.

Preferably, a concentration of thiosulfate in the electrolytic solution is 0.1-0.5 M, a concentration of the electrolytic solution is 0.1-0.5 M, and a concentration of the alkaline solution is 0.3-1.5 M.

Preferably, a concentration of thiosulfate in the electrolytic solution is 0.2-0.3 M, and a concentration of the electrolytic solution is 0.3-0.4 M.

Preferably, adjusting the pH of the electrolyte to 10-11 in the step S2.

Preferably, the thiosulfate is one or more of sodium thiosulfate, ammonium thiosulfate, or potassium thiosulfate; the alkaline solution is one or more of ammonia, sodium hydroxide, or potassium hydroxide.

Preferably, the electrolyte is one or two of chloride salts, sulfates, and carbonates.

Preferably, the materials containing precious metals are pure gold sheets, silver sheets, or waste printed circuit boards.

Preferably, the cathode of the electrolysis system is a titanium plate or a copper plate; the anode is one of platinum, titanium, copper, lead, glassy carbon, silicon carbide, stainless steel, graphite electrode, or graphite felt.

Preferably, the electrolytic cell is equipped with a diaphragm, which divides the electrolytic cell into a cathode chamber and an anode chamber.

Preferably, the diaphragm is made of acid and alkali resistant filter cloth or nylon mesh with a size of 600-800 mesh.

The advantages of the present invention are as follows:
(1) The present invention realizes the integrated short process extraction of precious metals by thiosulfate electrochemical leaching and recovery, which involves anodic oxidation leaching and cathodic reduction. This method achieves a gold leaching rate of 100% and a recovery rate of 99.8% within 24 h.
(2) The present invention greatly shortens the extraction time. Compared with traditional extraction processes, the extraction time of precious metals has been shortened from 65 h to 24 h.
(3) The present invention simplifies the process steps of precious metal extraction, has advantages such as high efficiency, low energy consumption, short flow range, and no pollution. It can achieve efficient and green one-step extraction of precious metals.

### BRIEF DESCRIPTION OF THE DRAWINGS

Accompanying drawings are for providing further understanding of embodiments of the disclosure. The drawings form a part of the disclosure and are for illustrating the principle of the embodiments of the disclosure along with the literal description. Apparently, the drawings in the description below are merely some embodiments of the disclosure, a person skilled in the art can obtain other drawings according to these drawings without creative efforts. In the figures:

FIG. 1 is a process flow diagram of extracting precious metals by traditional techniques;

FIG. 2 is a schematic diagram of the electrochemical leaching recovery integrated extraction process for precious metals of the present invention;

FIG. 3 is an effect diagram of extracting precious metals in one step of leaching recovery in Example 1;

FIG. 4 is an effect diagram of the integrated extraction of gold from PCBs by leaching and recovery in Example 2;

FIG. 5 shows the integrated extraction effect of gold leaching recovery in PCBs at different concentrations of S₂O₃²⁻;

FIG. 6 shows the integrated extraction effect of different KCl concentrations on gold leaching recovery in PCBs;

FIG. 7 shows the integrated extraction effect of gold leaching recovery in PCBs at different initial pH values.

### DETAILED DESCRIPTION OF PREFERRED EMBODIMENTS

The invention will be further described in detail in combination with embodiments to make the purpose, technical scheme, and advantages of the invention clear. The specific embodiments described herein are only used to explain the invention and are not intended to limit the invention.

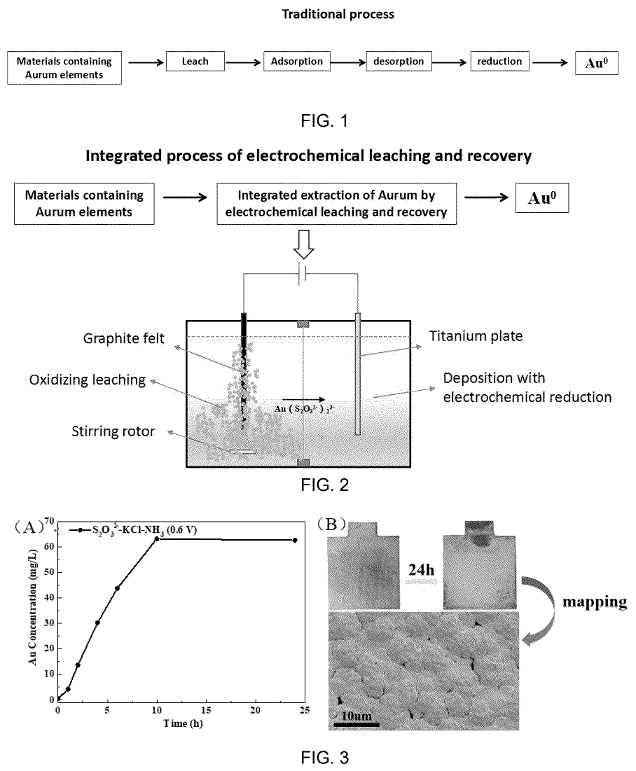

As shown in FIG. 1, when copper ammonia thiosulfate is used for gold leaching, the leachate after solid-liquid separation needs to be recovered from precious metals through processes such as adsorption desorption reduction. Traditional process flow has problems such as low efficiency, high drug consumption, high cost, and long time consumption.

Based on this, the present invention creatively proposes a method for extracting precious metals through an integrated short process of electrochemical leaching recovery of thiosulfate. At low voltage, the dissolution of precious metals through electrochemical anodic oxidation, while effectively combining with the cathode for the reduction recovery of leaching solution. It can achieve an integrated reaction of anodic mineral metal leaching and cathodic leaching solution electrolytic deposition in a single reaction device. This achieves an integrated extraction effect of simultaneous leaching and recovery, with advantages such as high extraction efficiency, short process flow, low reagent consumption, low energy consumption, and no pollution, making the metal extraction process safer and more cost-effective. As shown in FIG. 2, the present invention provides a method for extracting precious metals through a short process method for extracting precious metals by integrating thiosulfate electrochemical leaching and recovery, comprising the following steps:
S1, preparation of electrolytic solution: dissolving thiosulfate and chloride salts, adding alkaline solution, and stirring evenly to obtain the electrolytic solution; the concentration of thiosulfate in the electrolyte is 0.1˜0.5 M, preferably, 0.2˜0.3 M; the concentration of electrolyte is 0.1˜0.5 M, preferably, 0.3˜0.4 M; the concentration of alkaline solution is 0.3˜1.5 M. There is no limit to the types of thiosulfate, which can be one or more of sodium thiosulfate, ammonium thiosulfate, or potassium thiosulfate. There is no limit to the types of alkaline solutions, which can be one or more of ammonia, sodium hydroxide, and potassium hydroxide. Electrolytes are salts that do not contain thiosulfate, such as chloride salts, sulfates, or carbonates.
S2, adjusting the pH of the electrolytic solution to 7-13, with a preferred pH of 10-11; afterwards, the electrolyte and materials containing precious metals are placed in an electrolytic cell, and an electrode system located inside the cell is used for electrolysis reaction, allowing precious metals to leach at the anode and deposit at the cathode; The voltage for electrolysis reaction is 0.1-3 V. Materials containing precious metals can be pure gold, silver, or discarded circuit boards. The cathode of the electrolysis system is made of metal electrodes with good conductivity, such as titanium plates and copper plates, which need to be polished and prepared for future use; Anodes are electrode materials with good conductivity, such as platinum, titanium, copper, lead, glassy carbon, silicon carbide, stainless steel, graphite electrodes, and graphite felt. Preferably, the electrolytic cell is equipped with a diaphragm, which divides the electrolytic cell into a cathode chamber and an anode chamber. The diaphragm is made of acid and alkali resistant filter cloth or nylon mesh with a size of 600-800 mesh, used to prevent solid minerals or impurities in the anode chamber from entering the cathode.
S3, collecting precious metals deposited on the cathode.

The present invention is a novel electrochemical oxidation system of thiosulfate (S₂O₃²⁻-electrolyte-alkaline solution) that can achieve cathodic metal ion reduction while anodic oxidation leaching. The reaction of wet leaching of precious metals is essentially an oxidation-reduction reaction, in which precious metals lose electrons and are oxidized into precious metal ions. During the anode process, metal minerals collide with the anode to lose electrons, undergo electrochemical oxidation, and chelate with S₂O₃²⁻ to achieve leaching. The leached Au(S₂O₃²⁻)₂³⁻ reaches the cathode through concentration diffusion and convection, where electrons are reduced, thereby achieving simultaneous leaching and recovery. In the present invention, thiosulfate is used as a leaching complexing agent, and alkaline solution (such as ammonia) can prevent the insoluble products of thiosulfate from precipitating on the surface of gold during the dissolution process, such as elemental sulfur. When the alkaline solution is ammonia water, the formed complex M(S₂O₃)(NH)₃_{^{−}} can prevent the oxidation/disproportionation of unstable thiosulfates. The reaction formula is as follows:

Anode:Au+S₂O₃²⁻−e⁻=Au(S₂O₃²⁻)₂³⁻

Cathode:Au(S₂O₃²⁻)₂³⁻+e⁻=Au⁰+2S₂O₃²⁻

The following provides a detailed explanation of the present invention in conjunction with specific embodiments.

The calculation formula for the leaching rate and recovery rate of precious metals in the present invention is as follows:

$$Leaching rate = ( precious metal content in minerals before reaction -$$

$$precious metal content in residue after reaction ) /$$

$$precious metal content in minerals before reaction * 100 \% .$$

$$Recovery rate = ( precious metal content in minerals before reaction -$$

$$precious metal content in solution - precious metal content in residue ) /$$

$$precious metal content in minerals before reaction * 100 \% .$$

### Example 1

The electrolytic solution consists of 0.2 M Na₂S₂O₃, 0.2 M KCl, and 0.5 M NH₃, and is adjusted to pH₀=10 with sodium hydroxide.

Pour the reaction electrolytic solution of S₂O₃²⁻—KCl—NH₃ system into a cylindrical electrolytic cell. The anode is a pure mineral gold plate, and the cathode is a titanium plate with the same size as the anode. Connect a DC power supply, adjust the voltage to 0.6 V, and adjust the speed to 500 rpm for reaction. Samples are taken at different times, and the concentration of gold in the electrolytic cell at different time points is detected using atomic absorption spectroscopy. After 24 hours, collect the anode and cathode plates and clean and dry them. Comparing the quality of the anode and cathode plates before and after the reaction, and using scanning electron microscopy to capture the morphology of the cathode plate. Combined with the gold concentration in the solution and the cathode SEM image, evaluate the electrochemical oxidation leaching and electrodeposition reduction effects. The experimental results are shown in FIG. 3(A), it can be seen that the gold concentration in the solution remains around 63 mg/L from 10 hours to 24 hours. And FIG. 3(B) shows that the titanium plate on the cathode has changed from silver to a smooth golden yellow surface, and the deposition is covered with a large amount of gold elements, indicating that the gold plate plays a reducing role while the anode leaches. The leaching and reduction of gold can be achieved in the same system and device.

### Example 2

A method for extracting gold from PCBs by integrating thiosulfate electrochemical leaching and recovery comprises the following steps:

The electrolytic solution consists of 0.2 M Na₂S₂O₃, 0.3 M KCl, and 0.5 M NH₃, and is adjusted to pH₀=10 with sodium hydroxide.

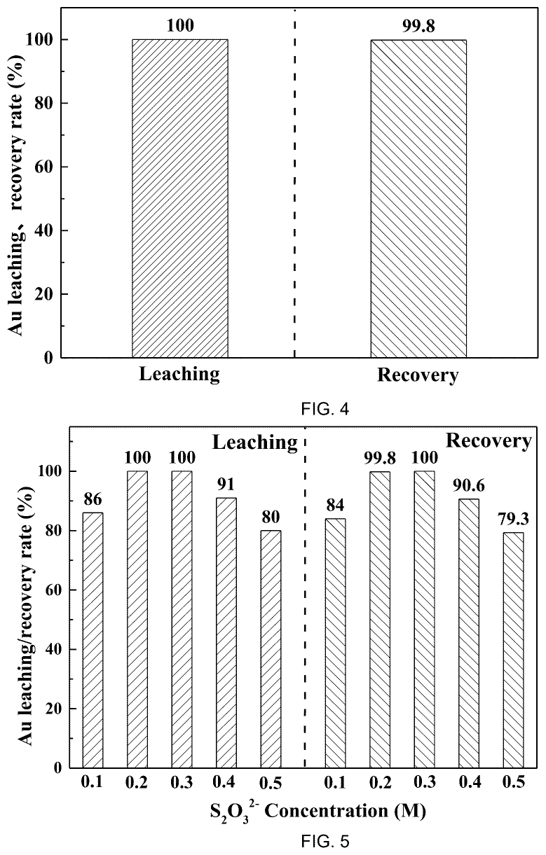

The electrolytic cell is separated by a 600 mesh nylon mesh in the middle and divided into an anode chamber and a cathode chamber to prevent solid minerals of PCBs from entering the cathode. Pour the reaction electrolyte of S₂O₃²⁻—KCl—NH₃ system into the anode and cathode chambers of the electrolytic cell, keeping the liquid level of the two chambers level. Place PCBs powder samples in the anode chamber, connect the anode and cathode electrodes, and use graphite felt (GF) as the anode. The cathode is a titanium plate with the same size as the anode, adjust the speed to 800 rpm, connect a DC power supply, adjust the voltage to 0.6 V, and then proceed with the reaction. After the reaction is completed, collect the solid slag from the anode chamber to measure the gold content, collect the cathode plate for drying and weighing, and calculate the leaching rate and recovery rate. The experimental results are shown in FIG. 4. Under this system, the gold leaching rate is 100% and the recovery rate is 99.8%.

### Example 3

A method for extracting gold from PCBs by integrating thiosulfate electrochemical leaching and recovery (with different concentrations of S₂O₃²⁻).

Prepare 5 different S₂O₃²⁻—KCl—NH₃ reaction electrolytic solutions with different concentrations of S₂O₃²⁻. The S₂O₃²⁻ concentrations are 0.1, 0.2, 0.3, 0.4, and 0.5 M. The other reagents are 0.3 M KCl and 0.5 M NH₃. The pH₀ of the electrolytic solution is 10.

The electrolytic cell is separated by a 600 mesh nylon mesh in the middle and divided into an anode chamber and a cathode chamber to prevent solid minerals of PCBs from entering the cathode. The prepared electrolytic solutions are poured into 5 electrolysis cells, keeping the liquid level of the anode and cathode chambers level. The same quality of PCB powder samples are placed in the anode chamber, and the anode and cathode are connected. The anode is made of GF and the cathode is made of titanium plate with the same size as the anode. The speed is adjusted to 800 rpm, and the DC power supply is connected. After adjusting the voltage to 0.6 V, the reaction is carried out. After the reaction is completed, the solid slag in the anode chamber is collected to measure the gold content. The cathode plate is collected, dried, and weighed to calculate the leaching rate and recovery rate. The experimental results are shown in FIG. 5, and it can be seen that different concentrations of S₂O₃²⁻ have a certain impact on the leaching rate and recovery rate. The best effect is achieved when the concentration of S₂O₃²⁻ is 0.3 M, with a gold leaching rate of 100% and a recovery rate of 100%.

### Example 4

A method for extracting gold from PCBs by integrating thiosulfate electrochemical leaching and recovery (with different concentrations of KCl).

Prepare 5 different S₂O₃²⁻—KCl—NH₃ reaction electrolytic solutions with different concentrations of KCl. The KCl concentrations are 0.1, 0.2, 0.3, 0.5, and 0.7 M. The other reagents are 0.2 M S₂O₃²⁻ and 0.5 M NH₃. The pH₀ of the electrolytic solution is 10.

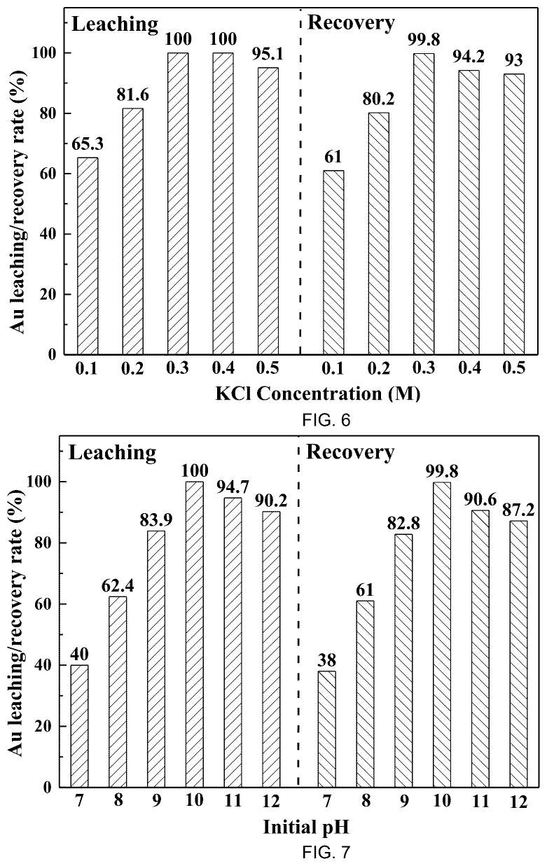

The electrolytic cell is separated by a 600 mesh nylon mesh in the middle and divided into an anode chamber and a cathode chamber to prevent solid minerals of PCBs from entering the cathode. The prepared electrolytic solutions are poured into 5 electrolysis cells, keeping the liquid level of the anode and cathode chambers level. The same quality of PCB powder samples are placed in the anode chamber, and the anode and cathode are connected. The anode is made of GF and the cathode is made of titanium plate with the same size as the anode. The speed is adjusted to 800 rpm, and the DC power supply is connected. After adjusting the voltage to 0.6 V, the reaction is carried out. After the reaction is completed, the solid slag in the anode chamber is collected to measure the gold content. The cathode plate is collected, dried, and weighed to calculate the leaching rate and recovery rate. The experimental results are shown in FIG. 6, and it can be seen that different concentrations of KCl have a certain impact on the leaching rate and recovery rate. The best effect of the leaching rate and recovery rate is achieved when the concentration of KCl is 0.3 M, with a gold leaching rate of 100% and a recovery rate of 99.8%.

### Example 5

A method for extracting gold from PCBs by integrating thiosulfate electrochemical leaching and recovery (with different pH₀).

Prepare 5 different S₂O₃²⁻—KCl—NH₃ reaction electrolytic solutions with different pH₀. The Initial pH values are 7, 8, 9, 10, 11, and 12. The other reagents are 0.2 M S₂O₃²⁻, 0.3 M KCl, and 0.5 M NH₃.

The electrolytic cell is separated by a 600 mesh nylon mesh in the middle and divided into an anode chamber and a cathode chamber to prevent solid minerals of PCBs from entering the cathode. The prepared electrolytic solutions are poured into 5 electrolysis cells, keeping the liquid level of the anode and cathode chambers level. The same quality of PCB powder samples are placed in the anode chamber, and the anode and cathode are connected. The anode is made of GF and the cathode is made of titanium plate with the same size as the anode. The speed is adjusted to 800 rpm, and the DC power supply is connected. After adjusting the voltage to 0.6 V, the reaction is carried out. After the reaction is completed, the solid slag in the anode chamber is collected to measure the gold content. The cathode plate is collected, dried, and weighed to calculate the leaching rate and recovery rate. The experimental results are shown in FIG. 7, and it can be seen that different pH₀ have a certain impact on the leaching rate and recovery rate. The best effect of the leaching rate and recovery rate is achieved when pH₀=10.

The above descriptions are only preferred embodiments of the present invention and are not intended to limit the present invention. Any modification, equivalent replacement, improvement, etc. made within the spirit and principle of the present invention shall be included in the protection of the present invention.

What is claimed is:

1. A short process method for extracting precious metals by integrating thiosulfate electrochemical leaching and recovery, comprising:
S1, dissolving a thiosulfate and an electrolyte, adding an alkaline solution, stirring evenly to obtain an electrolytic solution; the electrolyte is a salt that does not contain thiosulfate;
S2, adjusting the pH of the electrolytic solution to 7-13, then placing the electrolytic solution and materials containing precious metals in the electrolytic cell, and using an electrode system set in an electrolytic cell for electrolysis reaction, so that precious metals are leached at the anode and deposited at the cathode; the voltage of the electrolysis reaction is 0.1-3 V;
S3, collecting precious metals deposited on the cathode.

2. The short process method for extracting precious metals by integrating thiosulfate electrochemical leaching and recovery according to claim 1, wherein a concentration of thiosulfate in the electrolytic solution is 0.1-0.5 M, a concentration of the electrolytic solution is 0.1-0.5 M, and a concentration of the alkaline solution is 0.3-1.5 M.

3. The short process method for extracting precious metals by integrating thiosulfate electrochemical leaching and recovery according to claim 2, wherein a concentration of thiosulfate in the electrolytic solution is 0.2-0.3 M, and a concentration of the electrolytic solution is 0.3-0.4 M.

4. The short process method for extracting precious metals by integrating thiosulfate electrochemical leaching and recovery according to claim 1, wherein adjusting the pH of the electrolyte to 10-11 in step S2.

5. The short process method for extracting precious metals by integrating thiosulfate electrochemical leaching and recovery according to claim 1, wherein the thiosulfate is one or more of sodium thiosulfate, ammonium thiosulfate, or potassium thiosulfate; the alkaline solution is one or more of ammonia, sodium hydroxide, or potassium hydroxide.

6. The short process method for extracting precious metals by integrating thiosulfate electrochemical leaching and recovery according to claim 1, wherein the electrolyte is one or two of chloride salts, sulfates, and carbonates.

7. The short process method for extracting precious metals by integrating thiosulfate electrochemical leaching and recovery according to claim 1, wherein the materials containing precious metals are pure gold sheets, silver sheets, or waste printed circuit boards.

8. The short process method for extracting precious metals by integrating thiosulfate electrochemical leaching and recovery according to claim 1, wherein the cathode of the electrolysis system is a titanium plate or a copper plate; the anode is one of platinum, titanium, copper, lead, glassy carbon, silicon carbide, stainless steel, graphite electrode, or graphite felt.

9. The short process method for extracting precious metals by integrating thiosulfate electrochemical leaching and recovery according to claim 1, wherein the electrolytic cell is equipped with a diaphragm, which divides the electrolytic cell into a cathode chamber and an anode chamber.

10. The short process method for extracting precious metals by integrating thiosulfate electrochemical leaching and recovery according to claim 9, wherein the diaphragm is made of acid and alkali resistant filter cloth or nylon mesh with a size of 600-800 mesh.
